(19) United States
(12) Patent Application Publication
(10) Pub. No.: US 2005/0071868 A1
(43) Pub. Date: Mar. 31, 2005

(54) Information processing apparatus and information processing method

(75) Inventor: Osamu Yoshida, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/947,408

(22) Filed: Sep. 23, 2004

(30) Foreign Application Priority Data
Sep. 30, 2003 (JP) 2003-342326

(51) Int. Cl. H04N 5/445; G06F 3/00; H04H 9/00; H04N 7/16

(52) U.S. Cl. 725/39; 725/13; 725/51

(57) ABSTRACT

An information processing apparatus includes a reception portion which receives a broadcast signal and outputs a video signal, a display portion which displays an image corresponding to the video signal, an obtaining portion which obtains electric program information, an input portion which inputs information representing a predetermined channel and predetermined time, and a control portion which controls to extract a piece of program information from the electric program information in accordance with the predetermined channel and predetermined time and display it on the display portion. Since only a piece of program information is displayed, the electric program information can efficiently be displayed even on the small display screen of a cellular phone.

### CROSS-REFERENCE TO RELATED APPLICATIONS

This application is based upon and claims the benefit of priority from prior Japanese Patent Application No. 2003-342326, filed Sep. 30, 2003, the entire contents of which are incorporated herein by reference.

### BACKGROUND OF THE INVENTION

1. Field of the Invention

The present invention relates to an information processing apparatus having a broadcast reception function or mobile voice communication function and, more particularly, to an information processing apparatus which displays EPG (Electric Program Guide).

2. Description of the Related Art

Recently, digital TV broadcast is becoming popular. CS digital broadcast and BS digital broadcast have already started. Terrestrial digital broadcast is also scheduled to start. A characteristic feature of digital broadcast is use of EPG. In this technique, information of an electronized program table is transmitted together with a broadcast wave and received by a receiving device to reserve watching or recording of programs. In a general EPG display form, time is plotted along the ordinate, and channels are plotted along the abscissa (or vice versa). Program titles and the like are displayed in rectangular areas. It is difficult in some TV screen sizes to collectively display information for all channels and all time zones. Pieces of information for several channels and several hours are collectively displayed. A viewer selects a program from those displayed and reserves watching or recording. If a desired program is not present in the currently displayed window, the viewer scrolls the window in the horizontal or vertical direction to change the channel or time zone to display the desired program. Then, he/she reserves watching or recording.

Digital broadcast is planned to provide even low-rate programs which can be received and displayed not only by fixed TV sets but also by mobile TV receivers or cellular phones with TV tuners. In the EPG having the above-described matrix display form, however, characters are too small and cannot be identified. Hence, countermeasures are demanded.

There is a prior-art optical disk apparatus (Jpn. Pat. Appln. KOKAI Publication No. 2001-268028) in which to make program information easy to read, a keyword such as “football” is input as search information, and only program information corresponding to it is displayed on the screen instead of displaying all pieces of program information. In this case, only information desired by a user can efficiently be displayed as compared to display of all program information.

In this prior art, however, since a mobile TV receiver or cellular phone has a small display screen and a limited number of effective pixels, and accordingly, characters become indistinct, it is difficult to display a plurality of pieces of program information with good readability.

In addition, if the display range is made small in accordance with the small screen size, the window must be scrolled for a long time until a desired program is displayed. Since data acquisition and display are continuously done, loss of time is large, and the user feels stress until the desired program is displayed.

### BRIEF SUMMARY OF THE INVENTION

According to an aspect of the present invention, there is provided an information processing apparatus comprising a reception portion which receives a broadcast signal and outputs a video signal, a display portion which displays an image corresponding to the video signal from the reception portion, an obtaining portion which obtains electric program information of the broadcast signal, an input portion which inputs information representing a predetermined channel and a predetermined time, and a control portion which controls to extract a piece of program information from the electric program information in accordance with the predetermined channel and predetermined time input by the input portion and display the program information on the display portion.

### BRIEF DESCRIPTION OF THE SEVERAL VIEWS OF THE DRAWING

FIG. 1 is a block diagram showing an example of the arrangement of an information processing apparatus according to the first embodiment of the present invention;

FIG. 2 is a view showing an example of the outer appearance of the information processing apparatus according to the first embodiment of the present invention;

FIG. 3 is a block diagram showing another example of the arrangement of the information processing apparatus according to the first embodiment of the present invention;

FIG. 4 is a block diagram showing an example of the arrangement of an information processing apparatus according to the second embodiment of the present invention;

FIG. 5 is a block diagram showing an example of the arrangement of an information processing apparatus which communicates with the information processing apparatus according to the second embodiment of the present invention;

FIG. 6 is an explanatory view showing an example of the image obtaining method of the information processing apparatus according to the second embodiment of the present invention;

FIG. 7 is an explanatory view showing an example of the title specifying method of the information processing apparatus according to the second embodiment of the present invention;

FIG. 8 is an explanatory view showing another example of the title specifying method of the information processing apparatus according to the second embodiment of the present invention;

FIG. 9 is an explanatory view showing an example of the code specifying method of the information processing apparatus according to the second embodiment of the present invention;

FIG. 10 is a block diagram showing an example of the arrangement of an information processing apparatus according to the third embodiment of the present invention;

FIG. 11 is an explanatory view showing an example of the operation method of the information processing apparatus according to the third embodiment of the present invention;

FIG. 12 is an explanatory view showing the structure of EIT as electric program information to be processed by the information processing apparatus according to the present invention;

FIG. 13 is a flowchart showing an example of the processing method of the information processing apparatus according to the first embodiment of the present invention;

FIG. 14 is a flowchart showing an example of the processing method of the information processing apparatus according to the second embodiment of the present invention;

FIG. 15 is a block diagram showing an example of the arrangement of an information processing apparatus according to the fourth embodiment of the present invention; and

FIG. 16 is a block diagram showing an example of the arrangement of the mobile communication portion of the information processing apparatus according to the fourth embodiment of the present invention.

### DETAILED DESCRIPTION OF THE INVENTION

Information processing apparatuses according to the present invention will be described below in detail with reference to the accompanying drawing.

<First Embodiment of Present Invention>

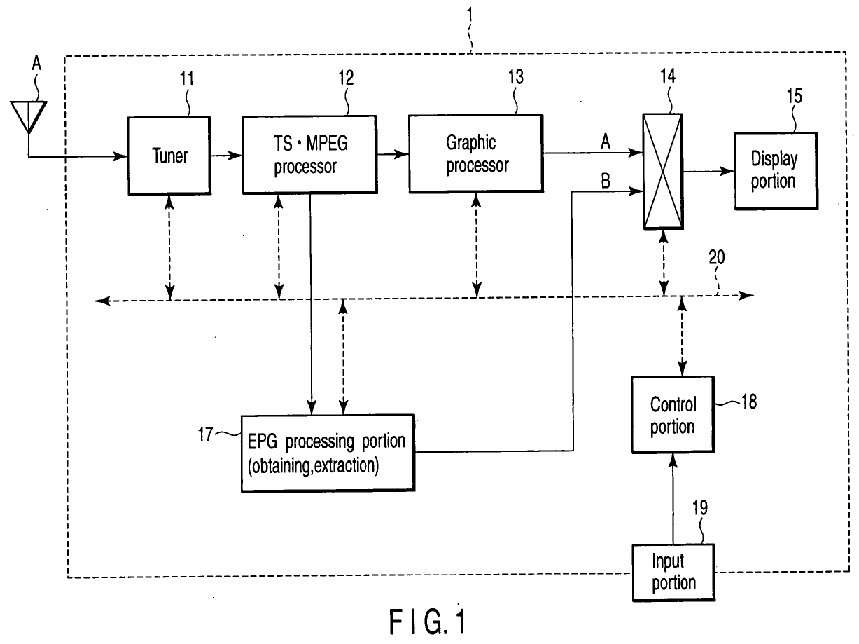

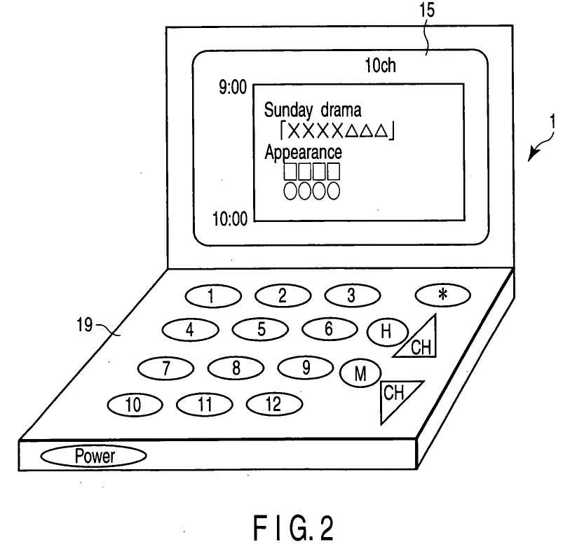

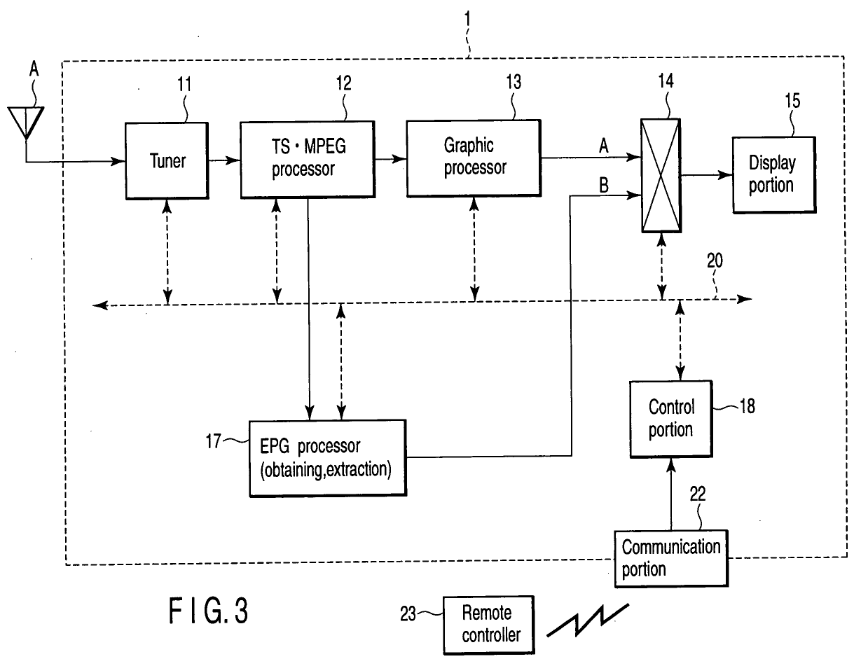

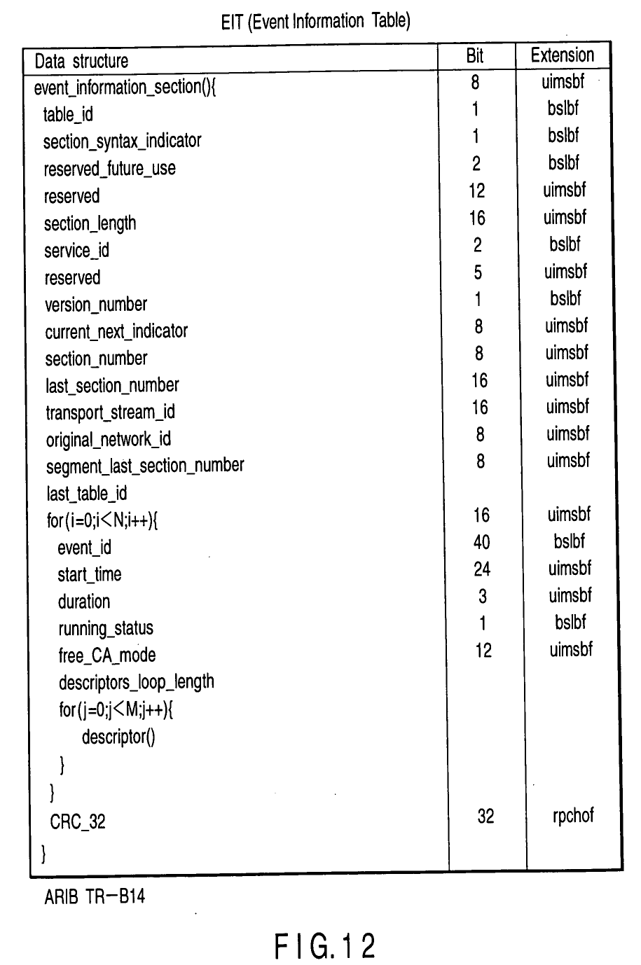

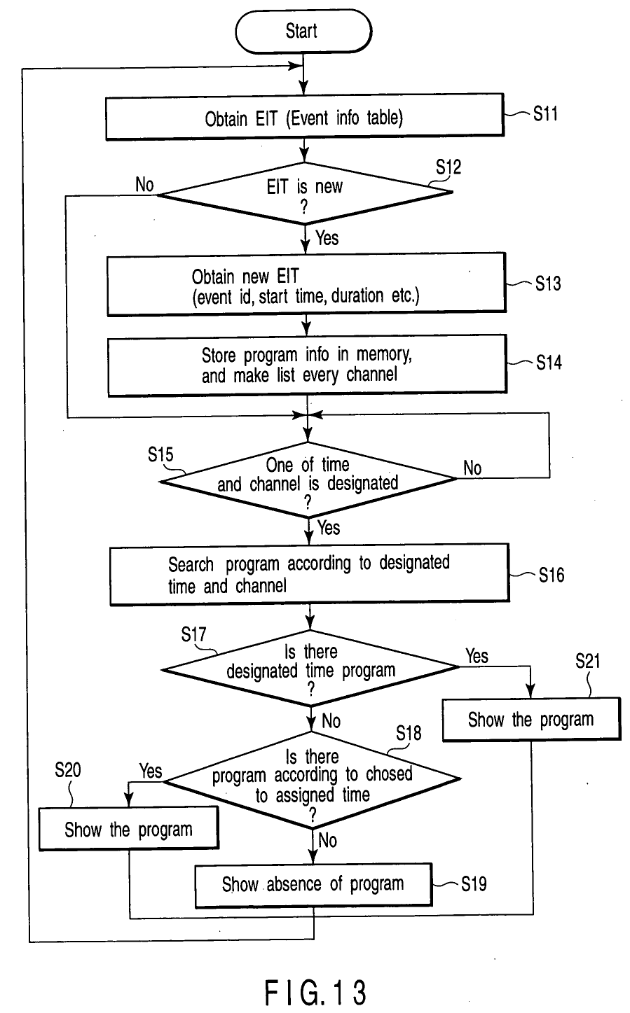

The first embodiment provides an information processing apparatus having a reception portion, a display portion, and an electric program information obtaining portion, which displays a piece of program information from electric program information on the display portion by inputting information related to a channel or time. FIG. 1 is a block diagram showing an example of the arrangement of an information processing apparatus according to the first embodiment of the present invention. FIG. 2 is a view showing an example of the outer appearance of the information processing apparatus according to the first embodiment of the present invention. FIG. 3 is a block diagram showing another example of the arrangement of the information processing apparatus according to the first embodiment of the present invention. FIG. 12 is an explanatory view showing the structure of EIT as electric program information to be processed by the information processing apparatus according to the present invention. FIG. 13 is a flowchart showing an example of the processing method of the information processing apparatus according to the first embodiment of the present invention.

(Arrangement)

An information processing apparatus 1 according to the present invention is, e.g., a mobile reception apparatus which has a reception function of receiving terrestrial digital broadcast or CATV. Referring to FIG. 1, the information processing apparatus 1 according to the present invention has a tuner 11 which receives a signal from the antenna and selectively receives one of programs broadcast by satellite broadcast, terrestrial digital broadcast, or CATV. The tuner 11 is connected to a data bus 20. The information processing apparatus 1 also has a TS•MPEG processor 12 and graphic processor 13 which are connected to the data bus 20. The TS-MPEG processor 12 demuxes a transport stream (TS) selected by the tuner 11 or decodes MPEG. The graphic processor 13 executes graphic processing of the decoded video signal.

The information processing apparatus 1 also has an EPG processing portion 17 which obtains EPG information as electric program information from the above-described TS•MPEG processor 12. The EPG processing portion 17 not only obtains EPG information but also extracts program information corresponding to information related to a channel and time from an input portion 19 and supplies the program information to a mixer 14 under the control of a control portion 18 (to be described later). The information processing apparatus 1 also has the mixer 14 and a display portion 15. The output from the EPG processing portion 17 and the output from the above-described graphic processor 13 are supplied to the mixer 14. An image signal selected by the mixer 14 is output to the display portion 15. The display portion 15 displays an image corresponding to the image signal.

The information processing apparatus 1 also has the control portion 18 and input portion 19. The control portion 18 is connected through the data bus 20 and controls the entire operation. The input portion 19 supplies an instruction signal or operation signal to the control portion 18. The input portion 19 also receives operation information from the control portion 18 and displays it on a liquid crystal screen or light-emitting diode. The input portion 19 receives an operation instruction from a user or indicates simple operation display. The input portion 19 corresponds to operation switches on the reception apparatus 1 or a remote controller (to be described later).

Information about EPG separated by the TS MPEG processor 12 is input to the EPG processing portion 17 so that an EPG window including a desired channel and time is formed under the control of the control portion 18 through the bus, as will be described later in detail. The formed EPG information is input to the mixer 14. An input A and input B are mixed at a predetermined ratio, and an EPG window is displayed on the display portion 15. The mixer 14 also operates as a selector by setting the mixing ratio of the inputs A and B to 100%:0% or 0%:100%. The control portion 18 controls the entire information processing apparatus 1. The control portion 18 receives information from the blocks or controls them through the control bus 20.

(Operation)

The operation of the information processing apparatus 1 according to the present invention will be described next in detail with reference to the view shown in FIG. 2, the explanatory view in FIG. 12 which shows the structure of EIT as electric program information, and the flowchart shown in FIG. 13.

The information processing apparatus 1 according to the present invention is, e.g., the mobile digital broadcast receiver 1 as shown in FIG. 2 and has the display screen 15 and input portion 19 as operation buttons. The operation buttons include, e.g., a power button, number buttons for channel designation, “hour” button, “minute” button, volume control button, and channel up and down buttons. To see a normal program, the apparatus is powered on by pressing the power button. For example, a channel selected last time is displayed on the screen. To see another channel, the channel is designated by the channel selection button.

To see a program from EPG, generally, an EPG window is displayed by pressing, e.g., an operation key such as “program guide” or “EPG”. A key corresponding to it is expressed here by (*).

When the (*) key is pressed, an EPG window based on the current time is normally displayed. The reference channel is generally a channel which is currently being received.

In this embodiment, when (1) to (12) keys are input next to the (*) key, EPG information for a desired channel and desired time can directly be displayed. Assume that the current time is 12:00 at noon, and the currently watched channel is 4ch. When the (*) key is pressed to display EPG, a program guide for 4ch at 12:00 is displayed. To check, e.g., “programs on 10ch from 9:00”, generally, the window is scrolled by using the up and down keys and even for the channel. This operation is cumbersome and time-consuming. Load on the control portion is also large.

In this example, when (*)+(10)+(9) is input, channel information and time information are input. As shown in FIG. 2, the program guide for 10ch from 9:00 can directly be displayed independently of the current reception channel. It is also suitable to input (number)+(H)+(number)+(M) by using the keys dedicated to designate “hour” and “minute”.

These processing operations will be described in more detail with reference to the explanatory view of EIT in FIG. 12 and the flowchart shown in FIG. 13. Referring to FIG. 13, the information processing apparatus 1 obtains EPG information in accordance with the function of the tuner 11 and TS•MPEG processor 12 by user operation or at a preset timing. The EPG information can be obtained either at the time of activation or automatically when no broadcast program is seen. Alternatively, it is suitable to automatically obtain EPG information at, e.g., a predetermined early-morning time when a broadcast program is generally watched at a low possibility.

In this way, under the control of the control portion 18, EIT (Event Information Table) as EPG information shown in FIG. 12 is obtained by the function of the tuner 11, TS•MPEG processor 12, and EPG processing portion 17 and stored in, e.g., a storage area (not shown) in the control portion 18 or a storage area (not shown) of the EPG processing portion 17 (S11). At this time, if the EIT is newer than the EIT used last time (S12), pieces of program information (event id, start time, duration, and the like) are obtained from the new EIT (S13). This program information is stored in a memory, and a list is made for every channel (S14).

As described above, when a desired time and channel are designated by using the (*) key and number keys (S15), a program according to the designated time and channel is searched for the lists of channels (S16). Of the EIT information, time information of one event id is obtained from the start time and duration. Channel information is obtained from the transport stream id. When there is a program corresponding to the designated time and channel (S17), the event id of the program is specified, and the program information is shown as in, e.g., FIG. 2 (S21).

On the other hand, when there is no program corresponding to the designated time (S17), a program for time close to the designated time is automatically searched for the lists (S18). An allowable range of, e.g., 15 min is set for the time shift. If the time shift falls within the range, program information in the allowable range is shown on the display portion 15 (S20). Program information whose time shift falls outside the allowable range is not shown. Instead, the absence of program is shown (S19).

As described above, in the image processing apparatus according to the first embodiment, information (e.g., a piece of program information) of an EPG window to be directly be displayed can be designated by key input (channel information and time information). Accordingly, the labor or stress for window scroll can be reduced.

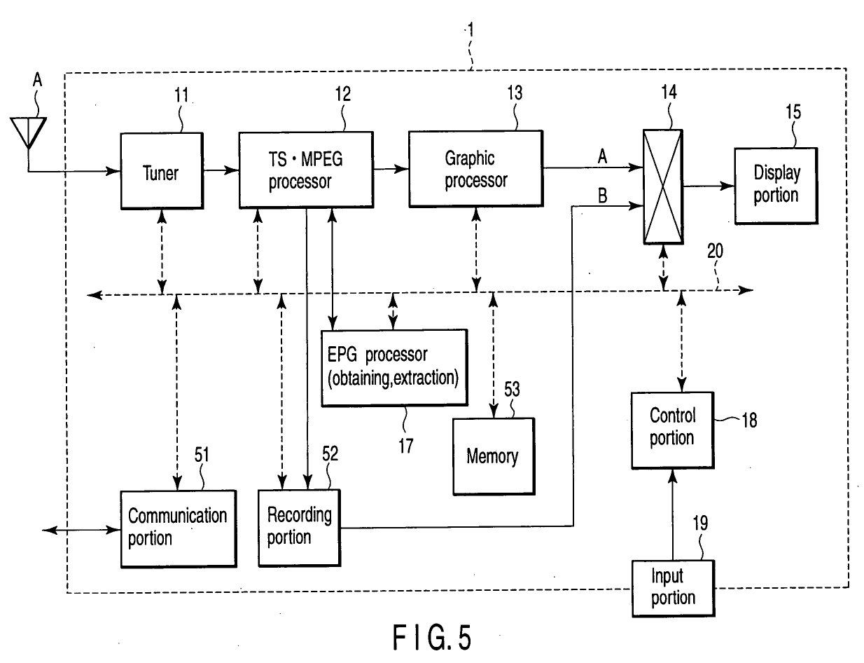

As will be described later with reference to FIG. 5, a recording portion 52 such as a hard disk which records video information and a memory 53 which stores reservation information are arranged. In this case, when the user executes operations for recording processing or recording reservation processing for a piece of program information, recording processing or recording reservation processing can be executed under the control of the control portion 18.

(Use of Remote Controller)

In the first embodiment, in the above-described example shown in FIG. 1, the display portion 15 and input portion 19 are arranged in one housing. The same processing as described is possible even in a TV set whose input portion 19 to be operated is separated from the display portion as a remote controller. FIG. 3 shows an example of the information processing apparatus 1 at this time. In place of the input portion 19, a remote controller 23 is arranged through a communication portion 22.

The remote controller 23 has almost the same arrangement as, e.g., that shown in FIG. 2 except the display portion 15 is not present. The key input operation and the like are executed in the same way as in the above-described example shown in FIG. 2.

The remote controller 23 has a key input portion, control portion, communication portion, and analysis portion. The key input portion has the same structure and function as in the information processing apparatus 1 shown in FIG. 1. The control portion controls the entire arrangement. The communication portion has a function of converting a predetermined signal into a predetermined code and decoding a received code to execute communication by a predetermined code in accordance with the same protocol as that of the communication portion 22 of the information processing apparatus 1 shown in FIG. 3. The analysis portion has a function of analyzing a program code (to be described later) and outputting at least channel information and time information.

Even when input is done by using the remote controller 23, desired channel information and time information input from the input portion of the remote controller 23 are converted into a coded signal by the communication portion and transmitted from the remote controller 23 to the communication portion 22 of the main body 1, like when input is done by using the input portion 19 of the main body shown in FIG. 1. After that, the signal is transmitted to the EPG processing portion 17 through the control bus 20. The EPG processing portion 17 displays, on the display portion 15, EPG information for a designated channel and designated time in accordance with the above-described procedures.

The remote controller 23 can also directly input a code number such as a G code. The input code number is converted into at least channel information and time information by the analysis portion and supplied to the communication portion. The communication portion converts the channel information and time information into a code of the protocol of the remote controller and transmits the code to the communication portion 22 of the main body of the information processing apparatus 1 shown in FIG. 3. Then, the code is transmitted to the EPG processing portion 17 through the control bus 20. The EPG processing portion 17 displays, on the display portion 15, EPG information for a designated channel and designated time in accordance with the above-described procedures.

The same operation as described above for the remote controller 23 or input portion 19 of the information processing apparatus 1 shown in FIG. 1 can also be executed by using a smaller number of buttons. In this case, it is suitable to employ the following algorithm. When channel information is to be input after input of the (*) key, the time interval of key input is measured. If the time interval is equal to or shorter than a predetermined interval, it is determined that channel input or time zone input follows. If the key input is done at an interval longer than the predetermined interval, it is determined that the key input is ended.

It is also suitable to do definition such that (*)+(10)+(9)+(*) means EPG display input for channel+time, and pressing the (*) key twice means simple EPG display and execute the operation on the basis of these definitions.

<Second Embodiment of Present Invention>

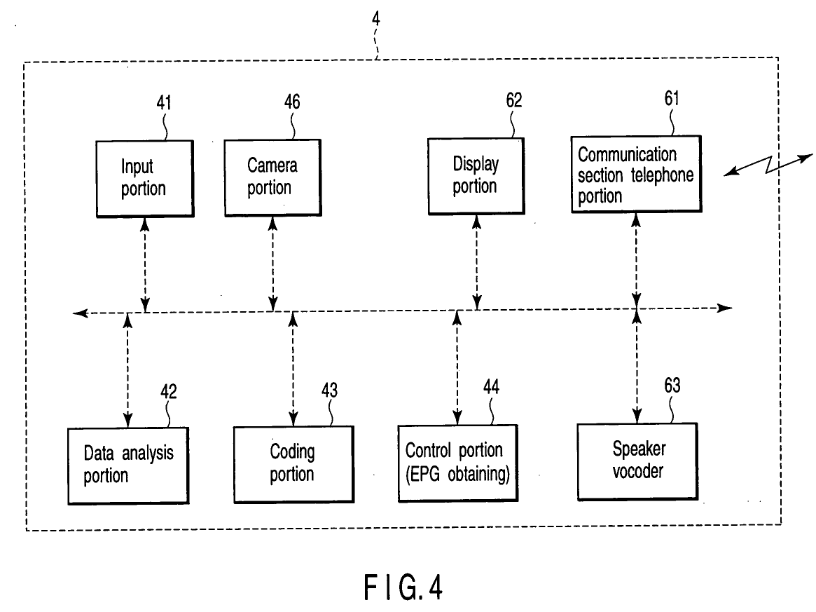

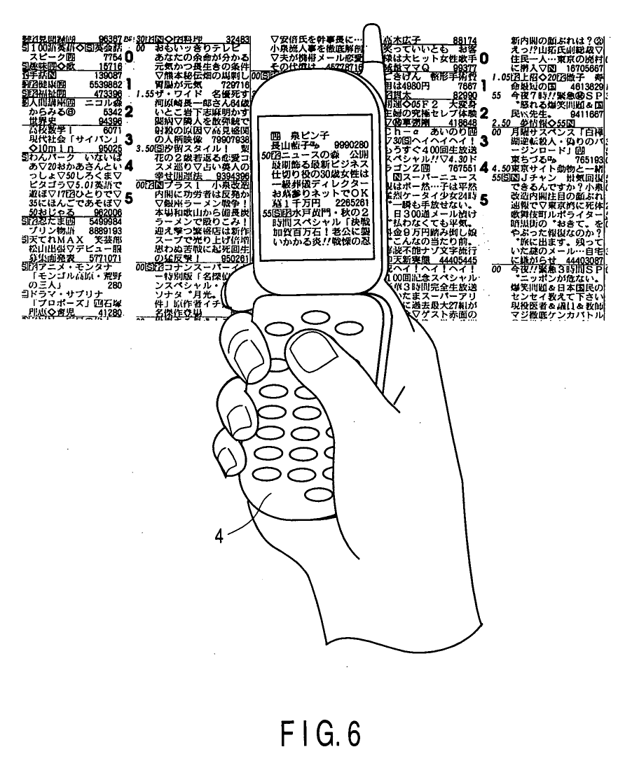

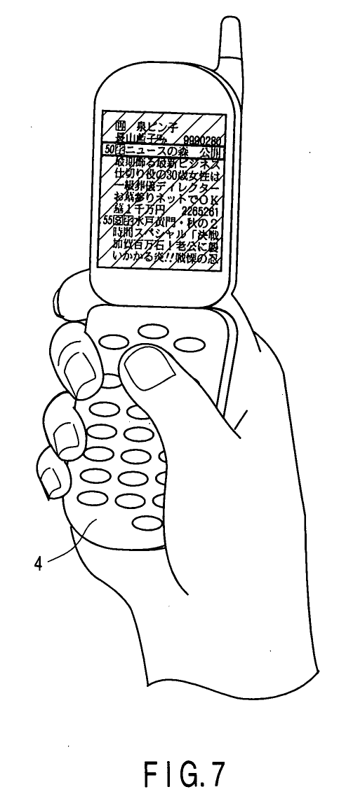

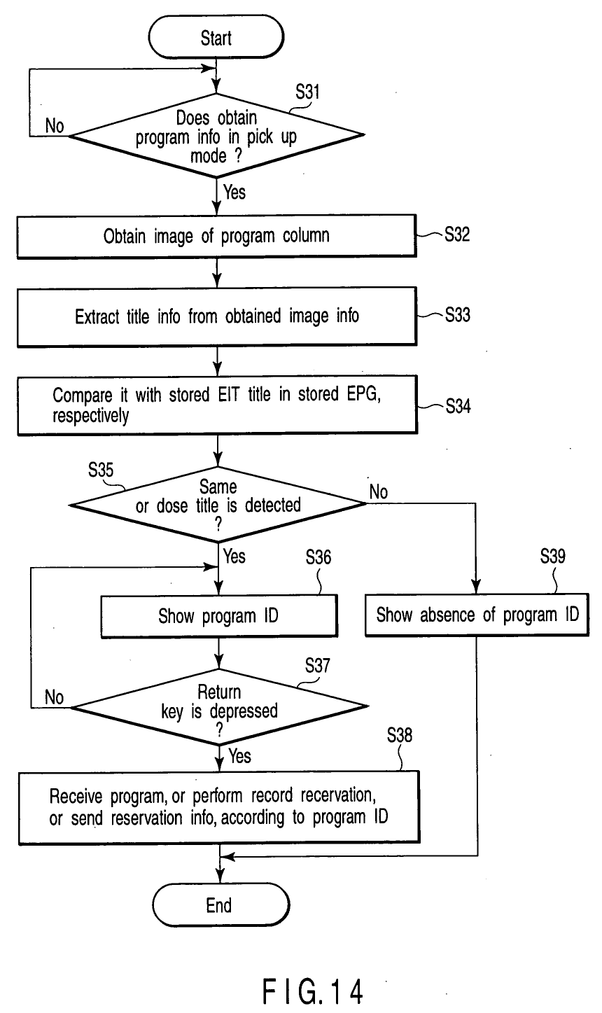

The second embodiment provides an information processing apparatus having a display portion, a camera portion, and an electric program information obtaining portion, which displays desired program information from electric program information on the display portion by inputting specific information in accordance with an image from the camera portion. FIG. 4 is a block diagram showing an example of the arrangement of an information processing apparatus according to the second embodiment of the present invention. FIG. 5 is a block diagram showing an example of the arrangement of an information processing apparatus which communicates with the information processing apparatus according to the second embodiment of the present invention. FIG. 6 is an explanatory view showing an example of the image obtaining method of the information processing apparatus according to the second embodiment of the present invention. FIGS. 7 to 9 are explanatory views showing an example of the title specifying method of the information processing apparatus according to the second embodiment of the present invention. FIG. 14 is a flowchart showing an example of the processing method of the information processing apparatus according to the second embodiment of the present invention.

(Arrangement)

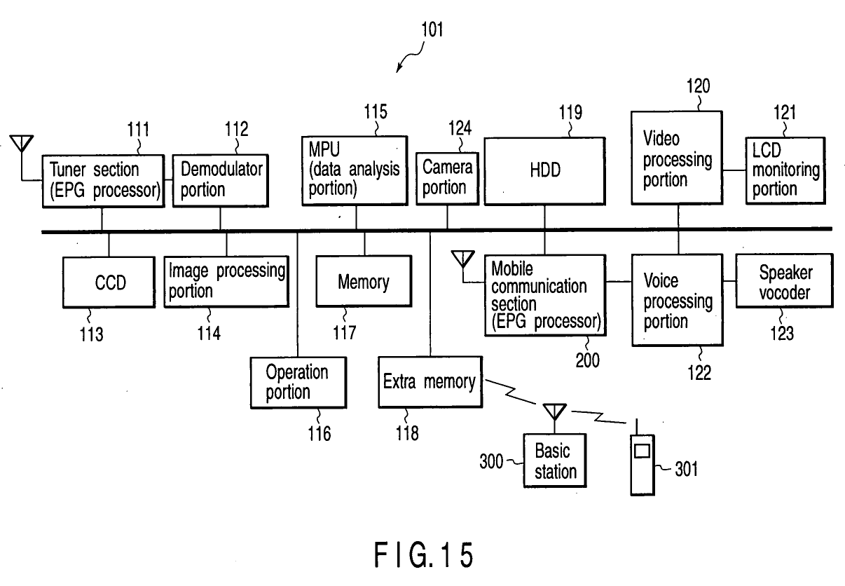

An example of the information processing apparatus used in the second embodiment has an arrangement such as a cellular phone. However, the present invention is not limited to this. An information processing apparatus 4 used in the second embodiment has an input portion 41 such as a ten-key pad or jog dial to input information, a camera portion 46 such as a CCD camera, a data analysis portion 42, a coding portion 43, and a display portion 62. The data analysis portion 42 analyzes an image sensed by the camera portion 46. The coding portion 43 generates code information. The display portion 62 such as a liquid crystal screen displays operation information or electric program information. The information processing apparatus 4 also has a communication section telephone portion 61, speaker vocoder 63, and control portion 44. The communication section telephone portion 61 can communicate with a receiver as an external information processing apparatus 1 or execute voice communication with another mobile station 301 by communicating with a basic station 300 shown in FIG. 15. The speaker vocoder 63 is used as a cellular phone function. The control portion 44 executes the entire operation.

FIG. 5 shows the information processing apparatus 1 such as a digital TV set capable of receiving reservation information from the information processing apparatus 4 and executing reserved recording processing. The information processing apparatus 1 shown in FIG. 5 has almost the same arrangement as the information processing apparatus 1 shown in FIG. 1. A description of common parts will be omitted. More specifically, the information processing apparatus 1 shown in FIG. 5 has a communication portion 51, memory 53, and recording portion 52. The communication portion 51 executes communication or LAN communication for wireless communication with the information processing apparatus 4 shown in FIG. 4. The memory 53 serves as a storage area in which a reservation list is stored. The recording portion 52 such as a hard disk is used to reserve and record video information of broadcast such as terrestrial digital broadcast. These components are connected to a data bus 20.

(Operation)

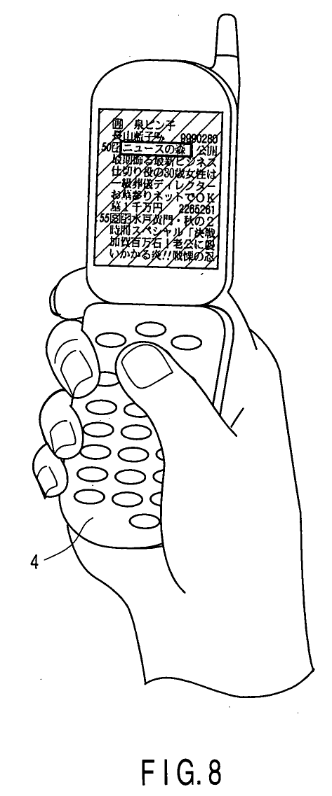

The operation of the information processing apparatus 4 having the above-described arrangement will be described. First, electric program information is obtained, as in step S11 of the flowchart shown in FIG. 13. It is suitable to automatically execute this processing, as described in the first embodiment. As shown in the explanatory views shown in FIGS. 6 to 9 and the flowchart shown in FIG. 14, when a pickup mode is selected to obtain program information by the camera portion 46 (S31), the user obtains an image of the program table of a newspaper or magazine, as shown in FIG. 6 (S32). After that, an image region is specified by the key operation to extract the title information of a program to be obtained (S33). As shown in FIG. 7, it is suitable to specify the image region by only simply setting a region in the vertical direction. Alternatively, as shown in FIG. 8, it is also suitable to set a region in the vertical and horizontal directions to properly specify the region of the title information. As will be described later, it is also suitable to specify and extract a region of not a program title but numbers such as a G code.

The data analysis portion 42 executes binarization processing for the image information of the specified region to identify the contour of a character image under the control of the control portion 44. The character image is also compared with a data for character identification in the data analysis portion 42, thereby identifying the title information as character information. After that, the identified title information is compared with title information in the EIT of the stored electric program information one by one.

The data analysis portion 42 can also directly sequentially scan the sensed image and analyze the title portion, as shown in FIG. 6. In this case, a character portion which follows a number such as 00 or 4.50 is recognized as a title, and database search is executed in the same way as described above. In the example shown in FIG. 6, pieces of information corresponding to a total of three programs are displayed. A title following a number “50” is set as the first candidate, and the above processing is executed.

EIT of electric program information here is obtained and stored by the same process as in steps S11 to S14 in the flowchart shown in FIG. 13. This process should be executed before step S31 in the flowchart shown in FIG. 14.

It is determined by comparison processing in step S34 whether title information which is the same or has a predetermined similarity or more is detected from EIT of the electric program information (S35). In determining the sameness of the title information of a program, a predetermined allowance (e.g., 70%) is set. In this case, even when the title region is set as shown in FIG. 7, an allowance to some extent can be ensured. If the same or close title is detected, the program ID is shown (S36). If NO in step S35, the absence of program ID is shown (S39).

When the program ID is shown on the display portion in step S36, and the return key is then operated to indicate the decision of the user (S37), the information processing apparatus 4 receives the program on the basis of the program ID. If the information processing apparatus 4 shown in FIG. 4 has a hard disk drive, reserved recording is executed. The information processing apparatus 4 can also transmit the program information to the information processing apparatus 1 serving as the reception apparatus as shown in FIG. 5 through the communication section 61 so that recording reservation can be executed (S38).

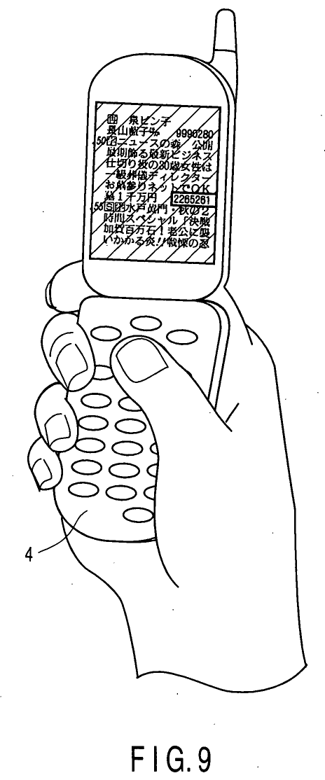

If the apparatus can handle number information such as a G code, as shown in FIG. 9, the data analysis portion 42 executes binarization processing for the image information of the specified region to identify the contour of the character image of the code number under the control of the control portion 44 in step S33. In addition, when a database prepared in advance in the data analysis portion 42 is analyzed for the code number, corresponding channel information and time information are identified. Then, it is determined whether information corresponding to the channel information and time information is detected from EIT of the electric program information (S35). If corresponding program information is present, the program ID is shown (S36). If NO in step S35, the absence of program ID is shown (S39).

When the program ID is shown on the display portion in step S36, and the return key is then operated to indicate the decision of the user (S37), the information processing apparatus 4 receives the program on the basis of the program ID. If the information processing apparatus 4 shown in FIG. 4 has a hard disk drive, reserved recording is executed. The information processing apparatus 4 can also transmit the program information to the information processing apparatus 1 serving as the reception apparatus as shown in FIG. 5 through the communication section 61 so that recording reservation can be executed (S38).

The information processing apparatus 4 according to the second embodiment is not limited to the embodiment. For example, barcode information is defined in association with channel information and time information in advance on the basis of a predetermined rule. A paper medium such as a newspaper or magazine shows the barcode information together with program introduction. After the camera portion 46 reads the barcode information, the data analysis portion 42 extracts channel information and time information. Then, the channel information and time information are supplied to the coding portion 43 through the data bus, converted into a code in accordance with the above-described rule, and transferred to the information processing apparatus 1 serving as the receiving apparatus as shown in FIG. 5 through a communication portion 45. Accordingly, reception processing or reserved recording processing can be executed.

The barcode information need not be shown as a program guide. For example, a program with an artist is shown as a barcode in a feature story of that artist so that the barcode can be input by the above-described method. In this case, the barcode can also be used as link information from an article.

As described above, according to the information processing apparatus of the second embodiment of the present invention, desired program information can be input by an intuitive operation from program information on a newspaper or magazine by using the camera portion 46 such as a CCD camera of the information processing apparatus 4 such as a cellular phone. Hence, reception processing or reserved recording processing can easily be executed.

<Third Embodiment of Present Invention>

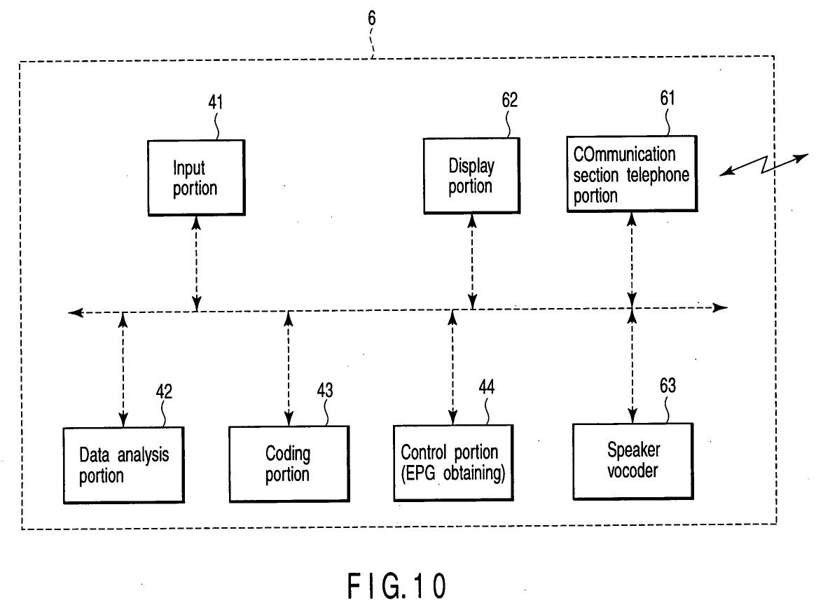

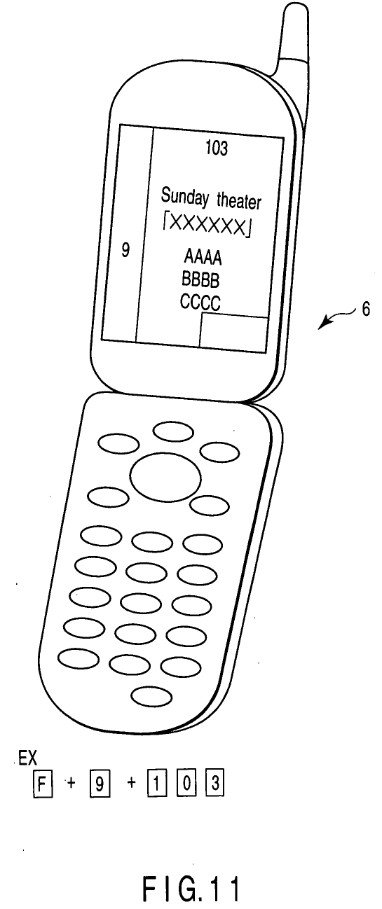

The third embodiment provides an information processing apparatus having a display portion and an electric program information obtaining portion, which displays a piece of program information from electric program information on the display portion by inputting specific information related to a channel or time. FIG. 10 is a block diagram showing an example of the arrangement of an information processing apparatus according to the third embodiment of the present invention. FIG. 11 is an explanatory view showing an example of the operation method of the information processing apparatus according to the third embodiment of the present invention.

(Arrangement and Operation)

In the third embodiment, an information processing apparatus 6 such as a cellular phone reserves a program through a network. Referring to FIG. 10, the information processing apparatus 6 has an input portion 41 such as a ten-key pad or jog dial to input information, a data analysis portion 42, a coding portion 43, and a display portion 62. The data analysis portion 42 analyzes data. The coding portion 43 generates code information. The display portion 62 such as a liquid crystal screen displays operation information or electric program information. The information processing apparatus 6 also has a communication section telephone portion 61, speaker vocoder 63, and control portion 44. The communication section telephone portion 61 can communicate with a receiver as an external information processing apparatus 1 or execute voice communication with another mobile station 301 by communicating with a basic station 300 shown in FIG. 15. The speaker vocoder 63 is used as a cellular phone function. The control portion 44 executes the entire operation.

The information processing apparatus 6 having the above-described arrangement reserves a program through a network and is implemented by, e.g., a cellular phone. The information processing apparatus has a telephone function as a cellular phone and a network communication function using a telephone line so that mail and access to the Internet are possible as well as voice communication.

The information processing apparatus 6 shown in FIG. 10 according to the third embodiment has no tuner 11, unlike the information processing apparatus 1 shown in FIG. 1 according to the first embodiment. Instead, the information processing apparatus 6 has the communication section telephone portion 61 to obtain electric program information through a network such as the Internet.

For the remaining processing, the same processing as in steps S11 to S21 in the flowchart shown in FIG. 13 which shows the operation of the first embodiment is executed. More specifically, assume that (*)+(8)+(9) is input from the input portion 41, as in the first embodiment. This is an instruction to display EPG for 8ch from 9:00. The control portion 44 drives the information processing apparatus 6, connects it to the Internet and to the EPG distribution site (not shown), transmits channel and time information, and obtains corresponding EPG information. The EPG information is sent to the display portion 62 so that the desired EPG window is displayed on the screen. FIG. 11 shows another input example. In this example, (F)+(9)+(103) is input, and a piece of program information of 103ch from 9:00 is specified and displayed.

In addition, as a characteristic feature of the information processing apparatus 6 according to the third embodiment, after the displayed contents are confirmed, key input representing reservation is done from the input portion 41. Then, a mail message containing the EPG information or channel and time information is created, transmitted from the information processing apparatus 6, and sent to a reception apparatus at the destination through the Internet. This operation is executed by storing a program in the storage area of the control portion 44.

The information need not always be sent by mail. It is also suitable to sent mail to a mail server or execute direct communication by FTP.

As described above, the information processing apparatus according to the third embodiment has no broadcast signal reception function, unlike the first embodiment. However, as in the first embodiment, not the whole of obtained electric program information but only a piece of program information (or some pieces of program information) is displayed on the basis of given channel information or time information. Even in a compact mobile information processing apparatus having a small screen, communication for every window scroll is unnecessary. Since the time necessary until the EPG of a desired program is displayed is shortened, and the communication amount decreases, an information processing apparatus capable of saving the communication fee for a subscription except a flat-rate plan can be provided.

<Information Processing Apparatus According to Fourth Embodiment of Present Invention>

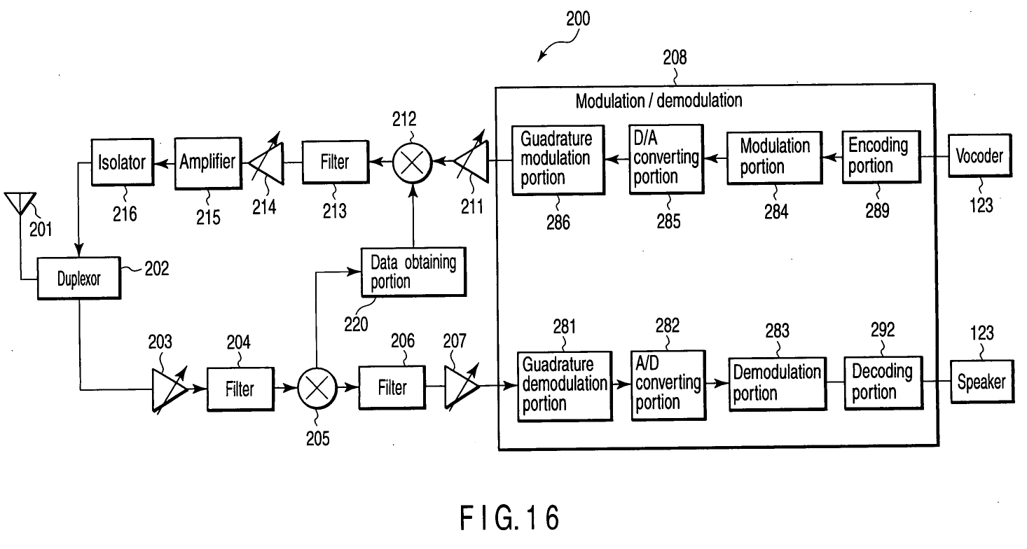

The fourth embodiment provides an information processing apparatus such as a cellular phone having a communication function with a more detailed arrangement, as in the second or third embodiment. FIG. 15 is a block diagram showing an example of the arrangement of an information processing apparatus according to the fourth embodiment of the present invention. FIG. 16 is a block diagram showing an example of the arrangement of the mobile communication portion of the information processing apparatus according to the fourth embodiment of the present invention.

An information processing apparatus 101 according to the present invention has a tuner section 111 and a demodulator portion 112, as shown in FIG. 15. The tuner section 111 receives, e.g., a normal high-quality broadcast (13 segment broadcast) as terrestrial digital broadcast and a low-date-rate broadcast (1 segment broadcast) mainly oriented to a portable TV set and obtains EPG (Electric Program Guidance) information as electric program information from the broadcast signal. The demodulator portion 112 demodulates the broadcast signal. These components are connected to a bus line. The information processing apparatus also has a CCD 113 and image processing portion 114. The CCD 113 receives a still image and moving image. The image processing portion 114 executes image processing for broadcast image information received by the tuner section 111 and demodulator portion 112 or still image information or moving image information received by the CCD 113. In addition, a memory 117 which stores various kinds of programs such as a game application is connected to the bus line. A mobile communication section 200 for a mobile phone function is also connected to the bus line.

An MPU 115 which controls the entire operation and an operation portion 116 which receives an operation instruction from a user are also connected to the bus line. The MPU 115 obtains the above-described electric program information extraction/display function of the first to third embodiments by operating together with the program in the memory 117. The information processing apparatus 101 also has an extra memory 118 to connect an externally detachable recording medium. The information processing apparatus also has a hard disk drive 119, video processing portion 120, LCD (Liquid Crystal Display) monitoring portion 121, voice processing portion 122, and camera portion 124. The hard disk drive 119 stores image information and voice information to be recorded and application programs. The video processing portion 120 processes and outputs video information such as a still image or moving image. The LCD monitoring portion 121 is connected to the video processing portion 120 to display the video. The voice processing portion 122 processes a voice signal and transmits/receives the voice signal to/from a vocoder speaker 123. The camera portion 124 such as a CCD camera is used for the above-described second embodiment.

As another embodiment of the information processing apparatus according to the present invention, it is also suitable to connect an adapter such as a tuner card for digital broadcast reception to a device such as a notebook PC and make it function as a mobile TV. In this case, demodulation processing in the tuner card should cope with both 13 segment broadcast and 1 segment broadcast. A compression-coded video or voice signal output from the tuner card is decoded by software by the CPU of the notebook PC. Normally, the compression-coding method changes between 13 segment broadcast and 1 segment broadcast. When the software is switched, both broadcast can be decoded.

The structure of the mobile communication section 200 for the above-described mobile phone function will be described with reference to FIG. 16. The mobile communication section 200 comprises an antenna 201, duplexor 202, RF reception gain variable amplifier 203, RF bandpass filer 204, frequency converter 205, IF bandpass filter 206, IF reception gain variable amplifier 207, modulation/demodulation portion 208, IF transmission gain variable amplifier 211, frequency converter 212, RF bandpass filter 213, RF transmission gain variable amplifier 214, power amplifier 215, isolator 216, vocoder 123, and speaker 123.

The modulation/demodulation portion 208 includes, e.g., a quadrature demodulation portion 281, A/D converting portion 282, information signal demodulation portion 283, and decoding portion 292. The modulation/demodulation portion 208 also includes an encoding portion 289 which encodes a signal from the vocoder, an information signal modulation portion 284, D/A converting portion 285, and quadrature modulation portion 286. In this arrangement, a signal quadrature-demodulated by the quadrature demodulation portion 281 is A/D-converted by the A/D converting portion 282, information-signal-demodulated by the signal demodulation portion 283, decoded by the decoding portion 292, and output.

Reception processing by the mobile communication section 200 having the above-described arrangement will be described. A forward link signal transmitted from the basic station 300 is received by the antenna 201. Only components in the reception signal band are filtered by the duplexor 202 and amplified or attenuated by the RF reception gain variable amplifier 203. Unnecessary components are filtered by the RF bandpass filer 204. Frequency conversion from the RF band to the IF band is done by the frequency converter 205. Unnecessary components are filtered by the IF bandpass filter 206. The remaining component is amplified or attenuated by the IF reception gain variable amplifier 207 and input to the modulation/demodulation portion 208.

A data obtaining portion 220 is connected to the frequency converters 205 and 212 so that information except voice information, and for example, browser information or application information such as a game on the Internet or EPG information as electric program information can be obtained through the frequency converter 205, or image information or operation information can be transmitted through the frequency converter 212. The data obtaining portion 220 is also connected to the MPU 115 serving as a control portion through a data bus (not shown).

The modulation/demodulation portion 208 also includes, e.g., the quadrature demodulation portion 281, A/D converting portion 282, information signal demodulation portion 283, information signal modulation portion 284, D/A converting portion 285, and quadrature modulation portion 286.

The encoding portion 289 and decoding portion 292 execute encoding and decoding by common encoding key information. With encoding processing, any illicit tapping of communicated voice information can be prevented. Strictly, it is only necessary that encoding key information for encoding from the mobile communication section on the transmitting side and key information of the decoding portion 292 on the receiving side are common.

Reception processing by the mobile communication section 200 having this arrangement will be described below. A signal quadrature-demodulated by the quadrature demodulation portion 281 is A/D-converted by the A/D converting portion 282, information-signal-demodulated by the information signal demodulation portion 283, decoded by the decoding portion 292, and output to the speaker 123 as voice.

Transmission processing by the mobile communication section 200 will be described below. A reverse link signal transmitted from a mobile station is given to a vocoder 123 and encoded by the encoding portion 289. The encoded signal is modulated by the information signal modulation portion 284, output, D/A-converted by the D/A converting portion 285, quadrature-modulated by the quadrature modulation portion 286, amplified or attenuated by the IF transmission gain variable amplifier 211, and frequency-converted from the IF band to the RF band by the frequency converter 212. Unnecessary components are filtered by the RF bandpass filter 213. The signal is amplified or attenuated by the RF transmission gain variable amplifier 214 and amplified by the power amplifier 215. Only components in the transmission signal band are filtered by the duplexor 202 through the isolator 216 and transmitted to the space through the antenna 201.

With the above-described arrangement, the information processing apparatus 101 according to the present invention can receive TV broadcast such as terrestrial digital broadcast, record the received broadcast signal on the HDD 119, or play back the recorded broadcast signal or externally provided moving image file by the functions of the tuner section 111 and demodulator portion 112 under the control of the MPU 115. A video signal obtained from the CCD 113 can also be recorded on the HDD 119, the recorded moving image file can be played back under the control of the MPU 115. Radio broadcast can be received and recorded by the functions of the tuner section 111 and demodulator portion 112, and a voice file stored in the HDD 119 can be played back by the functions of the demodulator portion 112 and voice processing portion 122. Recording and playback of a still image can also be executed. A video game mainly containing moving images and voice or a table game mainly containing still images can be played in accordance with the program stored in the memory 117 or HDD 119. In addition, communication with another telephone set can be performed by using the mobile phone function by the function of the above-described mobile communication section 200 under the control of the MPU 115. When another application program is stored in the HDD 119 and run under the control of the MPU 115, an arbitrary function can be obtained.

Even with this arrangement, the electric program information display function described in the first to third embodiments can be obtained for the same purpose as in the above-described case.

As described above, in the present invention, instead of displaying obtained electric program information wholly on the screen, only a piece of program information corresponding to a designated channel and time is displayed on the screen. Since the displayed information corresponding to only a piece of program information has a small amount, it can efficiently be displayed even in an information processing apparatus such as a cellular phone or mobile TV with a small screen.

In the present invention, an image of a program table on a newspaper or magazine is obtained by using an information processing apparatus such as a cellular phone with camera. A desired program title is selected from the image and compared with titles contained in electric program information obtained in advance. Program information having a most approximate title is extracted, and only this program information is displayed on the screen. Accordingly, even in an information processing apparatus such as a cellular phone or mobile TV with a small screen, reservation processing using electric program information can easily be done by an intuitive operation.

Those skilled in the art can implement the present invention by the above-described embodiments. Those skilled in the art can easily make various changes and modifications of these embodiments and can apply them to various embodiments without any inventive capability. The invention is therefore not limited to the above-described embodiments and incorporates a broader aspect without departing from the disclosed principle and novel features.

1. An information processing apparatus comprising:
a reception portion which receives a broadcast signal and outputs a video signal;
a display portion which displays an image corresponding to the video signal from the reception portion;
an obtaining portion which obtains electric program information of the broadcast signal;
an input portion which inputs information representing a predetermined channel and a predetermined time; and
a control portion which controls to extract a piece of program information from the electric program information in accordance with the predetermined channel and predetermined time input by the input portion and display the program information on the display portion.

2. An apparatus according to claim 1, wherein the input portion comprises a remote controller which transmits/receives a signal through a communication portion, and control is performed to extract, from the electric program information, a piece of program information corresponding to a signal representing a predetermined channel and predetermined time given from the remote controller through the communication portion and display the program information on the display portion.

3. An information processing apparatus comprising:
a display portion which displays an image;
an obtaining portion which obtains electric program information of a broadcast signal;
a camera portion which senses an image;
an analysis portion which analyzes the image sensed by the camera portion to extract predetermined information and compares the predetermined information with the electric program table to extract a piece of program information corresponding to the predetermined information; and
a control portion which controls to display the program information extracted by the analysis portion on the display portion.

4. An apparatus according to claim 3, further comprising an input portion which executes input to specify an effective region of the image sensed by the camera portion.

5. An apparatus according to claim 3, wherein the analysis portion analyzes the image sensed by the camera portion to extract a program title and compares the program title with the electric program table to extract a piece of program information corresponding to the program title.

6. An apparatus according to claim 3, wherein the analysis portion analyzes the image sensed by the camera portion to extract a program title and compares the program title with a program title in the electric program table to extract a piece of program information having a program title with not less than a predetermined similarity.

7. An apparatus according to claim 3, wherein the analysis portion analyzes the image sensed by the camera portion to extract a program code and extracts a piece of program information corresponding to the program code from the electric program table.

8. An information processing apparatus comprising:
a display portion which displays an image;
an obtaining portion which obtains electric program information of a broadcast signal;
an input portion which inputs a predetermined channel and a predetermined time; and
a control portion which controls to extract a piece of program information in accordance with the designated information and display the program information on the display portion.

9. An apparatus according to claim 8, further comprising a communication portion which transmits the piece of program information as reservation information by mail, the piece of program information corresponding to the predetermined channel and predetermined time designated by the input portion being extracted from the electric program information and displayed on the display portion.

10. An information processing method comprising:
obtaining electric program information of a broadcast signal;
inputting information representing a predetermined channel and predetermined time; and
extracting a piece of program information corresponding to the predetermined channel and predetermined time from the electric program information and displaying the program information on a display portion.

11. An information processing method comprising:
obtaining electric program information of a broadcast signal;
sensing an image, comparing predetermined information extracted by analyzing the image with the electric program table, and extracting a piece of program information corresponding to the predetermined information from the electric program table; and
displaying the piece of extracted program information on a display portion.
